(19) United States
(12) Patent Application Publication
(10) Pub. No.: US 2014/0046922 A1
(43) Pub. Date: Feb. 13, 2014

(54) SEARCH USER INTERFACE USING OUTWARD PHYSICAL EXPRESSIONS

(71) Applicants: Aidan C. Crook, Bellevue, WA (US); Nikhil Dandekar, Kirkland, WA (US); Ohil K. Manyam, Bellevue, WA (US); Gautam Kedia, Bellevue, WA (US); Sisi Sarkizova, Bellevue, WA (US); Sara Javanmardi, Bellevue, WA (US); Daniel Liebling, Seattle, WA (US); Ryen William White, Woodinville, WA (US); Kevyn Collins-Thompson, Seattle, WA (US)

(72) Inventors: Aidan C. Crook, Bellevue, WA (US); Nikhil Dandekar, Kirkland, WA (US); Ohil K. Manyam, Bellevue, WA (US); Gautam Kedia, Bellevue, WA (US); Sisi Sarkizova, Bellevue, WA (US); Sara Javanmardi, Bellevue, WA (US); Daniel Liebling, Seattle, WA (US); Ryen William White, Woodinville, WA (US); Kevyn Collins-Thompson, Seattle, WA (US)

(73) Assignee: Microsoft Corporation, Redmond, WA (US)

(21) Appl. No.: 13/570,229

(22) Filed: Aug. 8, 2012

(51) Int. Cl. G06F 17/30; G06F 3/033

(52) U.S. Cl. 707/706; 707/E17.108

(57) ABSTRACT

The disclosed architecture enables user feedback in the form of gestures, and optionally, voice signals, of one or more users, to interact with a search engine framework. For example, document relevance, document ranking, and output of the search engine can be modified based on the capture and interpretation of physical gestures of a user. The recognition of a specific gesture is detected based on the physical location and movement of the joints of a user. The architecture captures emotive responses while navigating the voice-driven and gesture-driven interface, and indicates that appropriate feedback has been captured. The feedback can be used to alter the search query, personalize the response using the feedback collected through the search/browsing session, modifying result ranking, navigation of the user interface, modification of the entire result page, etc., among many others.

### BACKGROUND

Users have natural tendencies to react with physical movement of the body or facial expressions when seeking information. When using a search engine to find information, the user enters a query and is presented with a list of results. To obtain results for a query, a ranker is trained by using external judges to label document relevance or using feedback collected through a user's interaction with the results page, primarily using mouse-driven inputs (e.g. clicks). However, this conventional input device interaction technique is cumbersome, limiting in terms of data reliability, and thus, the utility of the captured data.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables user feedback in the form of outward physical expressions that include gestures, and optionally, voice signals, of one or more users, to interact with a search engine framework. For example, document relevance, document ranking, and output of the search engine can be modified based on the capture and interpretation of physical gestures (and optionally, voice commands). The feedback includes control feedback (explicit) that operates an interface feature, as well as affective feedback (implicit) where a user expresses emotions that are captured and interpreted by the architecture.

The recognition of a specific gesture (which includes one or more poses) is detected based on the physical location of joints of a user and body appendage movements relative to the joints. This capability is embodied as a user interaction device via which user interactions are interpreted into system instructions and executed for user interface operations such as scrolling, item selection, and the like. The architecture captures emotive responses while navigating the voice-driven and gesture-driven interface, and indicates that appropriate feedback has been captured. The feedback can be used to alter the search query, modify result ranking, page elements/content, and/or layout, as well as personalize the response using the feedback collected through the search/browsing session.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary user interface that enables user interaction via gesture and/or voice.

FIG. 3 illustrates an exemplary user interface that enables user interaction via gesture and/or voice for a disagreement gesture.

FIG. 4 illustrates a system that facilitates detection and display of user gestures and input for search.

FIG. 5 illustrates one exemplary technique of a generalized human body model that can be used for computing human gestures for searches.

FIG. 6 illustrates a table of exemplary gestures and inputs that can be used for a search input and feedback natural user interface.

FIG. 7 illustrates a method in accordance with the disclosed architecture.

FIG. 8 illustrates further aspects of the method of FIG. 7.

FIG. 9 illustrates an alternative method in accordance with the disclosed architecture.

FIG. 10 illustrates further aspects of the method of FIG. 9.

FIG. 11 illustrates a block diagram of a computing system that executes gesture capture and processing in a search engine framework in accordance with the disclosed architecture.

### DETAILED DESCRIPTION

The disclosed architecture captures and interprets body/hand gestures to interact with a search engine framework. In one example, a gesture can be utilized to modify search results as part of a training data collection phase. For example, a gesture can be employed to provide relevance feedback of documents (results) for training data to optimize a search engine. Another gesture can be configured and utilized to alter the result ranking, and thus, the output of a search engine. For example, user expressed feedback can be by way of a gesture that dynamically modifies the search engine results page (SERP) or drills down more deeply (e.g., navigates down a hierarchy of data) into a specific topic or domain.

In one implementation, gestures can include a thumb-up pose to represent agreement, a thumb-down hand posture to represent disagreement, and a hands-to-face pose to represent confusion (or despair). It is to be understood, however, that the number and type of gestures are not limited to these three but can include others, such as a gesture for partial agreement (e.g., waving of a hand in a palm-up orientation) and partial disagreement (e.g., waving of a hand in a palm-down orientation), for example. Thus, there can be a wide variety of different outward physical expressions that represent emotions and operational commands that can be configured and communicated in this way. In other words, the type and number of gesture poses (time-independent) and time-dependent motions (e.g., a swipe) can be changed and extended as desired.

The disclosed architecture is especially conducive to a natural user interface (NUI). NUI may be defined as any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence. Specific categories of NUI technologies include touch sensitive displays, voice and speech recognition, intention and goal understanding, motion gesture detection using depth cameras (e.g., stereoscopic camera systems, infrared camera systems, RGB (red-green-blue) camera systems and combinations of these), motion gesture detection using accelerometers/gyroscopes, facial recognition, three-dimensional (3D) displays, head, eye, and gaze tracking, immersive augmented reality and virtual reality systems, all of which provide a more natural interface, as well as technologies for sensing brain activity using electric field sensing electrodes (EEG (electroencephalography) and related methods).

Suitable systems that can be applicable to the disclosed architecture include a system user interface, such as that provided by the operating system of a general computing system or multimedia console, controlled using symbolic gestures. Symbolic gesture movements are performed by a user with or without the aid of an input device. A target tracking system analyzes these movements to determine when a pre-defined gesture has been performed. A capture system produces depth images of a capture area that includes a human target. The capture device generates the depth images for 3D representation of the capture area, including the human target. The human target is tracked using skeletal mapping to capture the motion of the user. The skeletal mapping data is used to identify movements corresponding to pre-defined gestures using gesture filters that set forth parameters for determining when a target movement indicates a viable gesture. When a gesture is detected, one or more predefined user interface control actions are performed.

The user interface can be controlled, in one embodiment, using movement of a human target. Movement of the human target can be tracked using images from a capture device to generate a skeletal mapping of the human target. From the skeletal mapping it is determined whether the movement of the human target satisfies one or more filters for a particular gesture. The one or more filters may specify that the gesture be performed by a particular hand or by both hands, for example. If the movement of the human target satisfies the one or more filters, one or more user interface actions corresponding to the gesture are performed.

According to one technique for tracking user movement to control a user interface, the system includes an operating system that provides the user interface, a tracking system, a gestures library, and a gesture recognition engine. The tracking system is in communication with an image capture device to receive depth information of a capture area (including a human target) and to create a skeletal model that maps movement of the human target over time. The gestures library stores a plurality of gesture filters, where each gesture filter defines information for at least one gesture. For example, a gesture filter may specify that a corresponding gesture be performed by a particular hand, hands, an arm, torso parts such as shoulders, head movement, and so on.

The gesture recognition engine is in communication with the tracking system to receive the skeletal model, and using the gestures library, determines whether the movement of the human target (or parts thereof) satisfies one or more of the plurality of gesture filters. When one or more of the plurality of gesture filters are satisfied by the movement of the human target, the gesture recognition engine provides an indication to the operating system, which can perform a corresponding user-interface control action.

In one example, a plurality of gesture filters is provided that corresponds to each of a plurality of gestures for controlling an operating system user-interface. The plurality of gestures can include a horizontal fling gesture (where the user motions the hand or hand/arm generally along a horizontal plane as if turning pages of a book), a vertical fling gesture (where the user motions the hand or hand/arm generally along a vertical plane as if lifting or closing a lid of a container), a one-handed press gesture, a back gesture, a two-handed press gesture, and a two-handed compression gesture, for example. Movement of the human target can be tracked from a plurality of depth images using skeletal mapping of the human target in a known 3D coordinate system. From the skeletal mapping, it is determined whether the movement of the human target satisfies at least one gesture filter for each of the plurality of gestures. In response to determining that the movement of the human target satisfies one or more of the gesture filters, the operating system user interface is controlled.

In another suitable system to the disclosed architecture, user movement is tracked in a motion capture system. A user hand can be tracked in a field of view of the motion capture system over time, including obtaining a 3D depth image of the hand at different points in time. The 3D depth image may be used to provide a skeletal model of the user's body, for instance. An initial estimate of a location of the hand in the field of view can be obtained based on the tracking. The initial estimate can be provided by any type of motion tracking system. The initial estimate of the location may be somewhat inaccurate due to errors introduced by the motion tracking system, including noise, jitter and the utilized tracking algorithm. Accordingly, the difference of the initial estimate relative to a corresponding estimate of a prior point in time can be determined, and furthermore, if the difference is less than a threshold. The threshold may define a 2D area or a 3D volume which has the estimate of the prior point in time as its center. If the difference is less than the threshold, a smoothing process can be applied to the initial estimate to provide a current estimate of the location by changing the initial estimate by an amount which is less than the difference. This smoothing operation can be applied to hand/arm pose recognition as well.

On the other hand, if the difference is relatively large so as to not be less than the threshold, the current estimate of the location can be provided substantially as the initial estimate, in which case, no smoothing effect is applied. This technique minimizes latency for large frame-to-frame movements of the hand, while smoothing smaller movements. Based on the current estimate, a volume is defined in the field of view, such as a rectangular (including cubic) or spherical volume, as a search volume. The 3D depth image is searched in the volume to determine a new estimate of a location of the hand in the field of view. This search can include identifying locations of the hand in the volume and determining an average of the locations. A control input can be provided to an application which represents the hand in the field of view based, at least in part, on the new estimate of the location, or a value derived from the new estimate of the location. This control input can be used for navigating a menu, controlling movement of an avatar, and so forth.

A suitable gesture recognition implementation can employ joint mapping where a model is defined such that joints of a human body are identified as reference points such as the top of the head, bottom of the head or chin, right shoulder, right elbow, right wrist, and right hand represented by a fingertip area, for instance. The right and left side can be defined from the user's perspective, facing the camera. This can be the initial estimate of the hand location. The hand position can be based on a determined edge region (perimeter) of the hand. Another approach is to represent the hand position by a central point of the hand. The model can also include joints associated with a left shoulder, left elbow, left wrist, and left hand. A waist region can be defined as a joint at the navel, and the model also includes joints defined at a right hip, right knee, right foot, left hip, left knee, and left foot.

A user interaction component can be utilized, and manifested as a device that comprises a camera system, microphone system, audio system, voice recognition system, network interface system, as well as other systems that at least can drive a display. The device captures physical joint locations at an instant in time and in transitionary paths (e.g., swipes). The device enables skeletal tracking of user joint locations, imaging of the user and/or user environment via optical and infrared (IR) sensors and, capturing and recognition of voice commands including directional and location determination using beam-forming or other audio signal processing techniques. This application program interface (API) enables tracking the location of a user joints as a function of time. Specific gestures that utilize swiping motions of the arm and hand along with recognition of English spoken words in predefined sequences can be used to control navigation in the user interface.

The gestures can include natural behavior gestures and non-natural (or learned) behavior gestures. A natural behavior gesture (e.g., for providing relevance feedback) can comprise an outstretched hand with an upward thumb to flag a document as “LIKED”, which can be shared with friends via an online social network. Another natural behavior gesture can be a shrug of the shoulders, which can be detected and recognized as an indication of confusion about the provided results. Yet another natural behavior gesture can be defined as the placement of the user's head in hands, which is identified and associated with the emotion of despair. A non-natural behavior gesture can be a swipe motion that separates the hands, to control the user interface.

In other words, gestures and voice signals can be used to provide query input, perform search engine actions (e.g., result selection), and fine-tune search result relevance, to name a few. Historic preferences, archetypical preferences, or the result set distribution can be used to determine initial weights assigned to the different dimensions of relevance, as described herein below.

In addition to capturing expressive feedback from users (e.g., human judges), gestures and voice can be used as query input and the selection of result options. The user interaction component enables one or more users to adjust the weights of different dimensions (e.g., recency, diversity, complexity) serially or simultaneously, such as for result (document) relevancy. New weights assigned to the different dimensions can be used to dynamically reorder the search results shown to the user.

Selection can be performed by speaking the action that the system should take (e.g., “Select result 3”), by providing a gesture (e.g., by hovering over a search result to select it), or by a combination of voice and gesture. Voice and gesture technology is coupled with search engine re-ranking algorithms to assist users in expressing needs and exploring search results.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

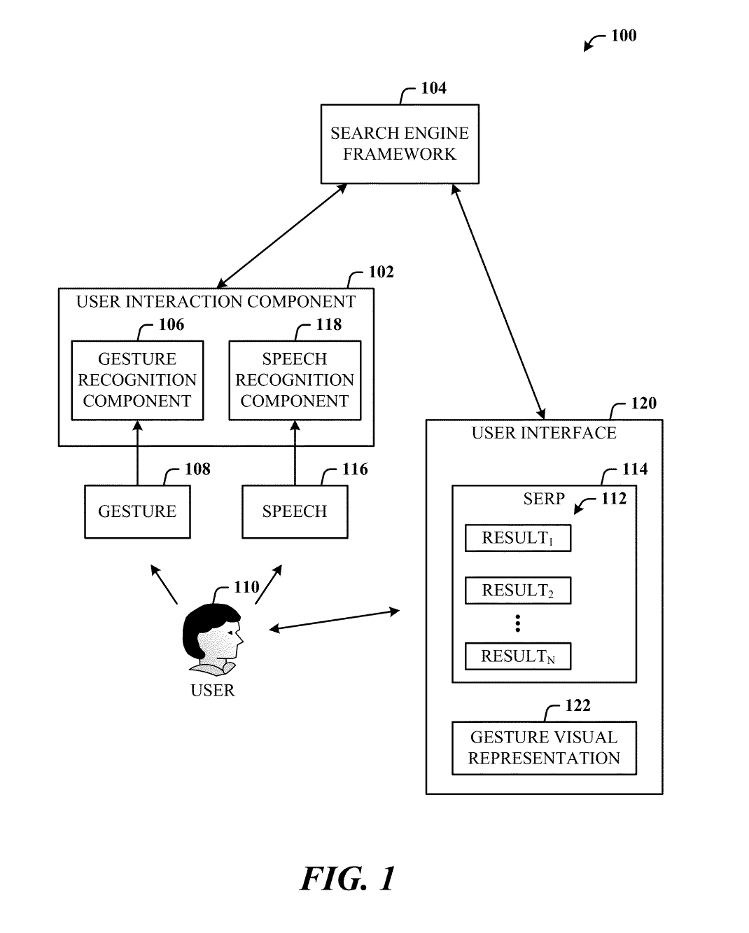

FIG. 1 illustrates a system 100 in accordance with the disclosed architecture. The system 100 can include a user interaction component 102 in association with a search engine framework 104 that employs a gesture recognition component 106 to capture and interpret a gesture 108 of a user 110 as interaction with the search engine framework 104. The gesture 108 is user feedback related to interactions with search results 112 (of a search engine results page (SERP) 114) by the user 110 to collect data (e.g., training, evaluation) for improving a user search experience via the search engine framework 104. The interactions can be related to tagging results (documents) for relevance, altering result ranking, drilling down on a specific topic, drilling down on a specific domain (type of content), and drilling down on attribute (website) dimensions, for example. Although shown as an ordered list, it is not a requirement that the results 112 be shown in such a list.

The user interaction component 102 can be implemented using a Kinect™ device by Microsoft Corporation, for example. The user interaction component 102 captures (image, video) and processes (interprets) gestures at least in the form of natural behavioral movements (e.g., hand swipes, arm swoops, hand movements, arm movements, head movements, finger movements, etc.) and speech 116 (voice signals) (via a speech recognition component 118) based on commands (e.g., learned) understood by the component 102 to control navigation of a user interface 120. Audio direction-finding and/or location-finding techniques such as from beam-forming (e.g., to distinguish voice commands from different speakers by direction) can be employed as well. More generally, the user interaction component 102 can use the speech recognition component 118 to recognize voice signals received from the user that facilitate interaction with the user interface 120 of the search engine framework 104. The voice signals can include signals that enable and disable capture and interpretation of the gesture 108.

The user interaction component 102 can also be configured to detect general user motion such as moving left (e.g., stepping left, leaning left), moving right (e.g., stepping right, leaning right), moving up (e.g., jumping, reaching), and moving down (e.g., crouching, bending, squatting), for example. A gesture and/or voice signal can be received from the user as a trigger to start gesture recognition, stop gesture recognition, capture of user movements, start/stop speech recognition, and so on.

The user interaction can be solely gesture-based, solely speech-based, or a combination of gesture and speech. For example, gestures can be employed to interact with search results 112 and speech (voice signals) can be used to navigate the user interface 120. In another example, gestures can be used to interact with search results 112 (e.g., thumb-up hand configuration to indicate agreement with a result, thumb-down hand configuration to indicate disagreement with a result, closed first to indicate confusion, etc.) and navigate the user interface 120 (e.g., using up/down hand motions to scroll, left/right hand swipes to navigate to different pages, etc.).

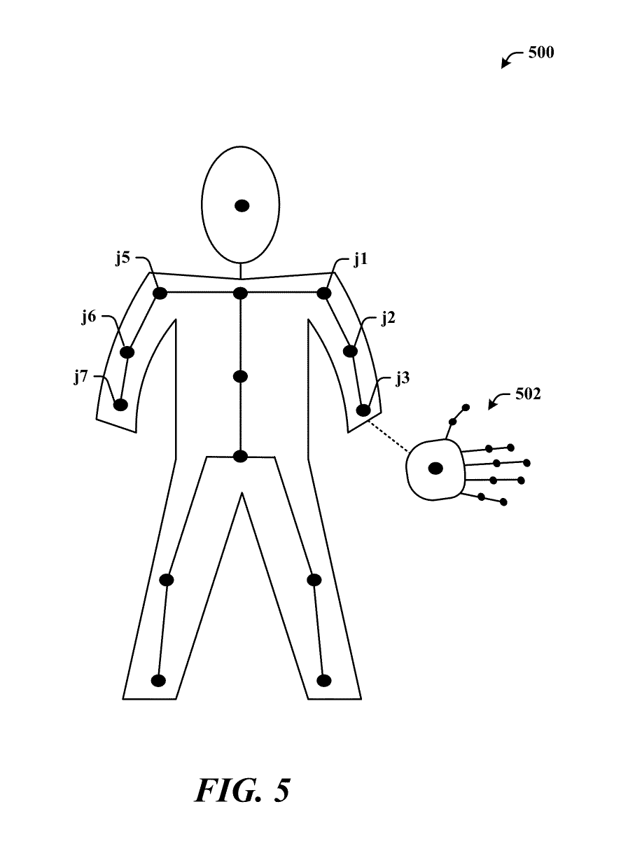

The gesture 108 is recognized by the gesture recognition component 106 based on capture and analysis of physical location and movement related to joints and/or near the joints of the skeletal frame of the user and/or signals provided by the image, video, or IR component, any or all of which can be detected as a function of time. In other words, the human body can be mapped according to joints (e.g., hand to forearm at the wrist, forearm to upper arm at the elbow, upper arm to torso at the shoulder, head to torso, legs to torso at hip, etc.), and motions (transitionary paths) related to those joints. Additionally, the physical joint locations are captured as a function of time. This is described in more detail with respect to FIG. 5.

A transitionary path defined by moving the right hand (open, or closed as a first) from right to left in an approximately horizontal motion, as captured and detected by the gesture recognition component 106, can be configured to indicate navigation back to a previous UI page (document or view) from an existing UI page (document or view). As previously, the user interaction component 102 can be employed to collect data that serves as a label to interpret user reaction to a result via gesture recognition of the gesture 108 related to a search result (e.g., RESULT₂). The data collected can be used for training, evaluation, dynamic adjustment of aspects of the interface(s) (e.g., a page), and for other purposes. The gesture 108 of the user 110 is captured and interpreted to navigate in association with a topic or a domain. In other words, the gesture is captured and interpreted for purposes of navigating within, with respect to, or with preference to, one or more topics and/or domains. The gesture 108 is captured and interpreted to dynamically modify results of the SERP 114. This includes, but is not limited to, modifying the page, generating a new result set, updating an existing set (e.g., by re-ranking). The gesture 108 relates to control of the user interface 120 (e.g., generate a new page) and user interface elements associated with the search engine framework 104.

The captured and interpreted gesture 108 is confirmed as a gesture visual representation 122 on the user interface 120 that is similar to the gesture. For example, if the user 110 gave a thumb-up gesture for a result (e.g., RESULT₁), which indicates agreement with selection and tagging of the result as relevant, the gesture visual representation 122 can be a computer-generated graphic of a thumb-up hand pose to indicate the gesture received. The user 110 can then confirm that the gesture visual representation 122 agrees with what the user 110 intended, after which the associated instruction (tag as relevant) is executed.

It can be the case that the gesture visual representation 122 is simply text, such as the word “AGREE”, and/or audio output as a spoken word “Agree” or “Like”, which matches the user intent to tag the result as relevant. User confirmation can also be by voice signals (e.g., “like” or “yes”) or a confirmation gesture (e.g., a circular motion of a hand that indicates to move on). Thus, the gesture 108 is one in a set of gestures, the gesture interpreted from physical joint analysis as a natural physical motion that represents agreement (e.g., thumb-up, up/down head motion, etc.), disagreement (e.g., thumb-down, side-to-side head motion, etc.), or confusion (e.g., closed fist, shoulder shrug, hands on face, etc.). The gesture 108 can comprise multiple natural behavior motions captured and interpreted as a basis for the feedback. In other words, the gesture 108 can be the thumb-up hand plus an upward motion of the hand.

The result ranking of the results 112 can be changed in response to relevance tagging of results (e.g., RESULT₁ and RESULT₂) via the gesture 108. The user interactions with the results include relevance tagging of results via the gesture to change result ranking For example, if the judging user selects the second result (RESULT₂) before the first listed result (RESULT₁), the current ranking of the first result above the second result can then be changed to move the second result above the first result.

The gesture 108 can be interpreted to facilitate retrieval of web documents based on a query or an altered query presented to the user 110. For example, after the user (or the system) enters a query (e.g., by keyboard, by voice, etc.), the gesture 108 (e.g., a circular motion by a closed first) can be captured and interpreted to then execute the query to retrieve the web documents for that query. If the user (or system) then inputs an altered query, based on results of the previous query, the gesture 108 (e.g., a circular motion by a closed first) can be captured and interpreted to then execute the altered query to retrieve the web documents associated with that altered query.

The gesture 108 and/or the effect of the gesture (e.g., re-ranking results) can be communicated electronically to another user (e.g., on a social network). For example, it can be the case that the user is a member of a group of users that are judging the results 112 as training data, where some or all of the members are distributed remotely, rather than being in the same setting (e.g., room). Thus, it can be beneficial for members to see the gestures of other members, who are serving as human judges for this training process, for example. The gesture 108 of the user 110 can be communicated to one or more other judges via text messaging (“I like”), image capture (image of the user 110 with a thumb-up gesture), voice signals (user 110 speaking the word “like”), live video communicated to the other members, and so on. In another example, this information can be shared with other users (“friends”) of a social network.

In a group setting where multiple users are in the same view of the user interaction component 102, the user interaction component 102 can operate to capture and interpret gestures (and/or audio/voice signals) individually (discriminate) from the user and other users that are collectively interacting with the search engine framework to provide feedback. The user and the other users can each interact with aspects of result relevance, for example, and in response to each user interaction the search engine framework dynamically operates to adapt to a given user interaction.

Put another way, the user interface enables one or more users to form gestures that dynamically control the ranking of a list of search results provided by the search engine. This control enables the rapid exploration of the result space and quick adjustment of the importance of different result attributes. Natural behavioral gestures can be employed throughout a search session to disambiguate the user intent in future ambiguous queries. The gesture-driven interface provides a visual on-screen response to the detected gestures. The architecture includes time-varying gesture detection components used to control the user interface (e.g., via swipe left/right). The speech interface processes words such that cues to start and stop the detection are available (e.g., starting speech with the word “Bing”). The architecture facilitates the retrieval of web documents based on the query/altered query that are shown to the user. The search results can be re-ordered in response to the labels obtained via the gestures. The speech mechanism also employs thresholds for speech detection to discriminate voice signals from background noise as well as on a per user basis to detect input of one user from another user, in a multi-user setting.

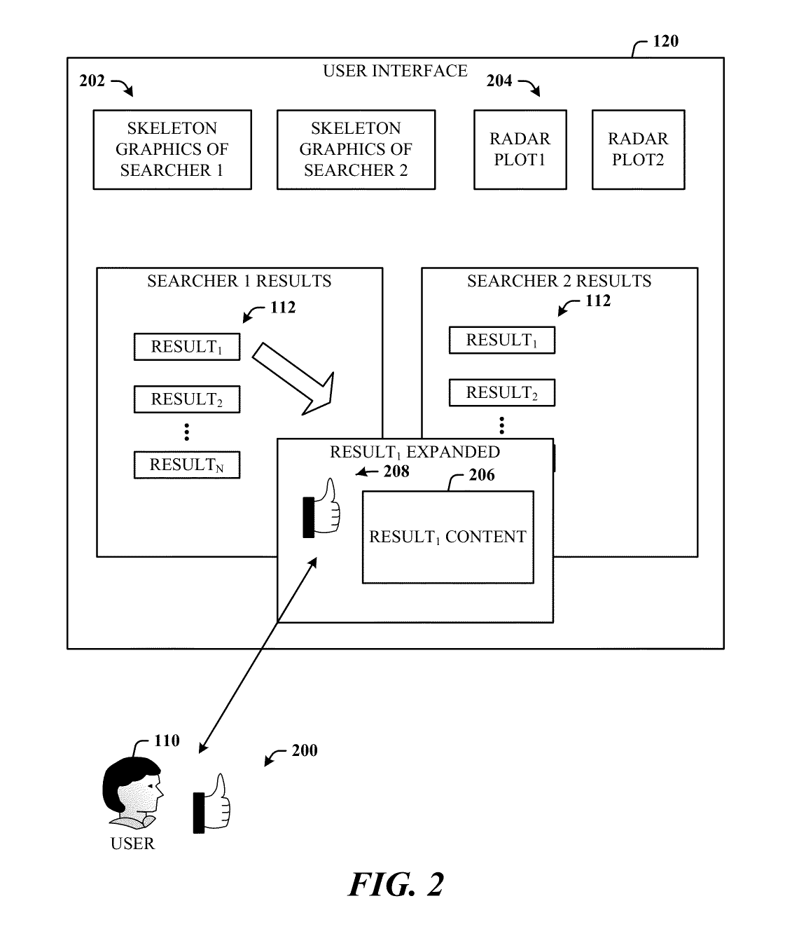

FIG. 2 illustrates an exemplary user interface 120 that enables user interaction via gesture and/or voice for an agreement gesture 200. In one implementation of the user interface 120, skeleton graphics 202 placed at the top depict the two users of the system: Searcher 1 and Searcher 2, as represented by skeletal tracking of the user interaction component 102. The results on the left are the results returned for Searcher 1 and the results on the right are the results for Searcher 2. Only a small number of results 112 (e.g., the top five) returned by the search engine are shown to avoid the user having to scroll. The results for each searcher can also be different sets. However, this is a configurable setting and scrolling can be permitted if desired for larger sets.

In response to an initial query communicated via keyboard, speech, or gestural input (e.g., on a word wheel), the sets of results are returned to each searcher. Multiple sets of search results can be returned, typically one set per user. Each result has a weight along different dimensions and enables users (searchers) with a way to dynamically control the weights used to rank the results in their set. In one implementation for relevance processing, the weights are computed for each result for each of the relevance dimensions: in this case, the amount of picture content, the recency (closeness to a specific date, time) of the information, and the advanced nature of the content. The dimensions can be displayed as a chart (e.g., bar) next to each result (e.g., on the left of this result).

These weights can be computed for each search result offline or at query time. For example, the number of images can be computed by parsing the content of the document, the advanced nature of the document can be computed via the complexity of the language used, and the recency can be computed using the date and time the document was created or last modified.

Once the weights have been assigned to the associated set of search results along different dimensions of relevance, the user(s) (searchers) can adjust an interface control to reflect user preferences and have the result list updated. In one example, the interface control can be a radar plot (of plots 204) via which the user adjusts the weights assigned to the different relevance dimensions. There can be one radar plot for each user. Users can adjust their plots independently and simultaneously. It is to be appreciated that a radar plot is only one technique for representing the different relevance dimensions. For example, a three-dimensional (3D) shape with each face representing a dimension, can be used and manipulated to reflect importance of the different dimensions.

A dimension can be controlled (e.g., by moving the right hand gesture horizontally or vertically), but multiple dimensions could also be controlled simultaneously by using other parts of the body (e.g., by moving the right and left hands at the same time, hands plus feet, etc.). Searcher 2 can select a “Pictures” dimension and adjust its weight by raising the right hand (which would be visible in the skeleton of Searcher 1). Note that the architecture can also be used by a single user rather than multiple users as described herein. Moreover, although only three dimensions are described, this can be expanded to include any number of dimensions, including dimensions that vary from query to query and/or are personalized for the user(s).

To help users more effectively interact with the control, the control can also indicate information about the distribution of results in the set (e.g., by overlaying a histogram over each of the dimensions to show the distribution of weights across the top-n results). The control can also be preloaded to reflect user preferences or likely preferences given additional informational about searcher demographics or other information (e.g., children may prefer pictures and less advanced content).

As the user expands a result (Result₁) to view the associated result content 206, the user 110 decides here to agree with the result and its content by posing a thumb-up gesture as the agreement gesture 200. As confirmation, the system presents its interpreted gesture 208 for the user 110. Thereafter, the user 110 can voice a command (e.g., “next”) to move to the next result, or pause for a timeout (e.g., three seconds) to occur after the interpreted gesture 208 is presented, and so on. Alternatively, other commands/gestures can be used such as an arm swoop to indicate “move on”.

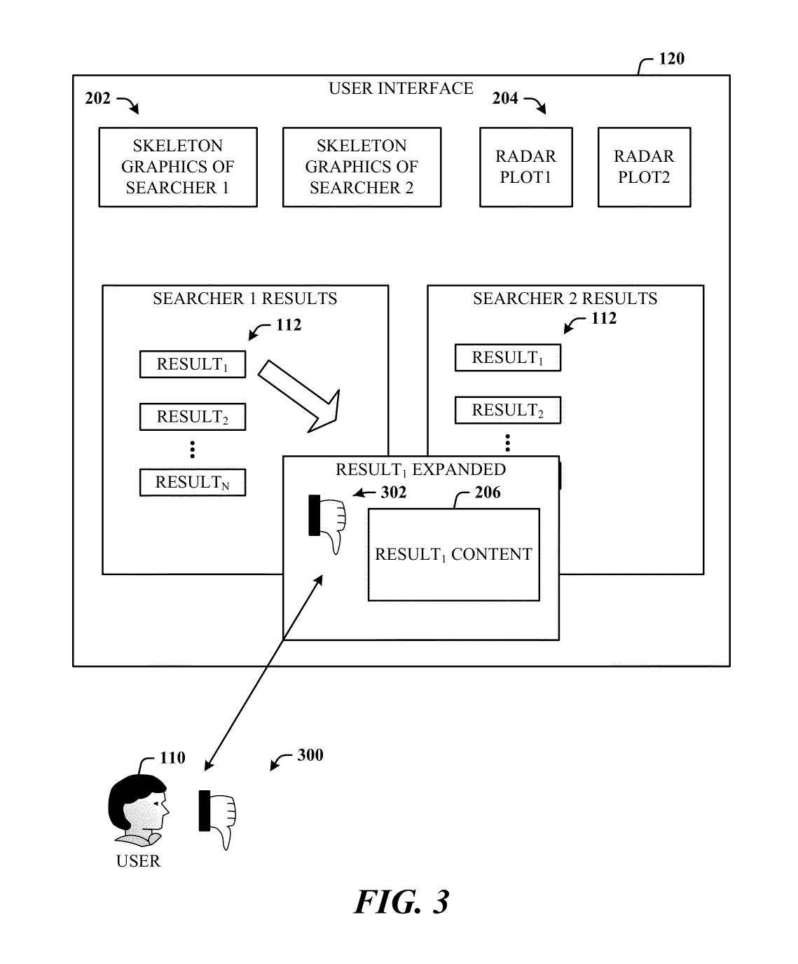

FIG. 3 illustrates an exemplary user interface 120 that enables user interaction via gesture and/or voice for a disagreement gesture. For brevity, the above description for the agreement gesture 200 applies substantially to the disagreement gesture. As the user expands the result (Result₁) to view the associated result content 206, the user 110 decides here to disagree with the result and its content by posing a thumb-down gesture as the disagreement gesture 300. As confirmation, the system presents its interpreted gesture 302 for the user 110. Thereafter, the user 110 can voice a command (e.g., “next”) to move to the next result, or wait for a timeout (e.g., three seconds) to occur after the interpreted gesture 302 is presented, and so on. Alternatively, other commands/gestures can be used such as an arm swoop to indicate “move on”.

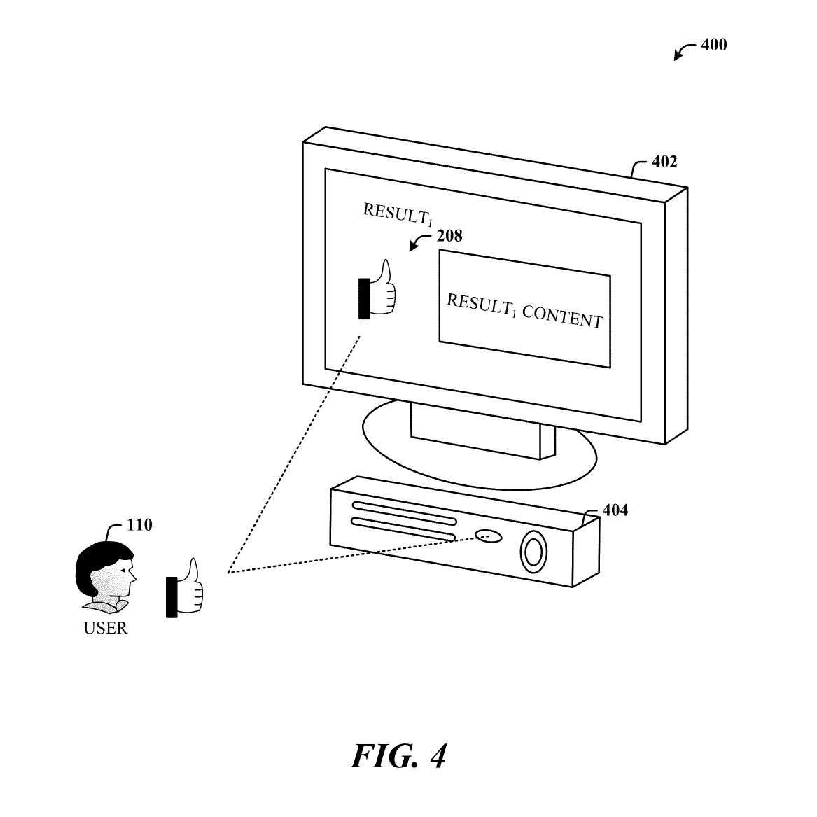

FIG. 4 illustrates a system 400 that facilitates detection and display of user gestures and input for search. The system 400 includes a display 402 (e.g., computer, game monitor, digital TV, etc.) that can be used for visual perception by the user 110 of at least the user interface 120 for search results and navigation as disclosed herein. A computing unit 404 includes the sensing subcomponents for speech recognition, image and video recognition, infrared processing, user input devices (e.g., game controllers, keyboards, mouse, etc.), audio input/output (microphone, speakers), graphics display drivers and management, microprocessor(s), memory, storage, application, operating system, and so on.

Here, the thumb-up gesture is shown as an agreement gesture for the results. The gesture is image captured (e.g., using the joint approach described herein) and interpreted agreement gesture 208 for agreeing to the display result and result content.

FIG. 5 illustrates one exemplary technique of a generalized human body model 500 that can be used for computing human gestures for searches. According to one embodiment, the model 500 can be characterized as having thirteen joints j1-j13 for arms, shoulders, abdomen, hip, and legs, which can then be translated into a 3D model. For example, a joint j1 can be a left shoulder, joint j2, a left elbow, and a joint j3, a left hand. Additionally, each joint can have an associated vector for direction of movement, speed of movement, and distance of movement, for example. Thus, the vectors can be used for comparison to other vectors (or joints) for translation into a gesture that is recognized by the disclosed architecture for a natural user interface.

The combination of two or more joints also then defines human body parts, such as joints j2-j3 define a left forearm. The left forearm moves independently, and can be used independently or in combination with the right forearm, characterized by joints j6-j7. Accordingly, the dual motion of the left forearm and the right forearm in a predetermined motion can be interpreted to scroll up or down in the search interface, for example.

This model 500 can be extended to the aspects of the hands, such as at finger tips, joints at the knuckles, and wrist, for example, to interpret a thumb-up gesture separately or in combination with the arm, arm movement, etc. Thus, the static orientation of the hand 502 can be used to indicate a stop command (palm facing horizontally and away from the body), a question (palm facing upward), vertically and downward (reduce the volume), and so on. In this particular illustration, the left hand is interpreted as in a thumb-up pose for agreement with the content presented in the user interface of the search engine.

As a 3D representation, angular (or axial) rotation can further be utilized for interpretation and translation in the natural user interface for search and feedback. For example, the axial rotation of the hand relative to its associated upper arm can be recognized and translated to “increase the volume of” or “reduce the volume of”, while the projection of the index finger in a forward direction and movement can be interpreted to move in the direction.

It is to be appreciated that the voice commands and other types of recognition technologies can be employed separately or in combination with gestures in the natural user interface.

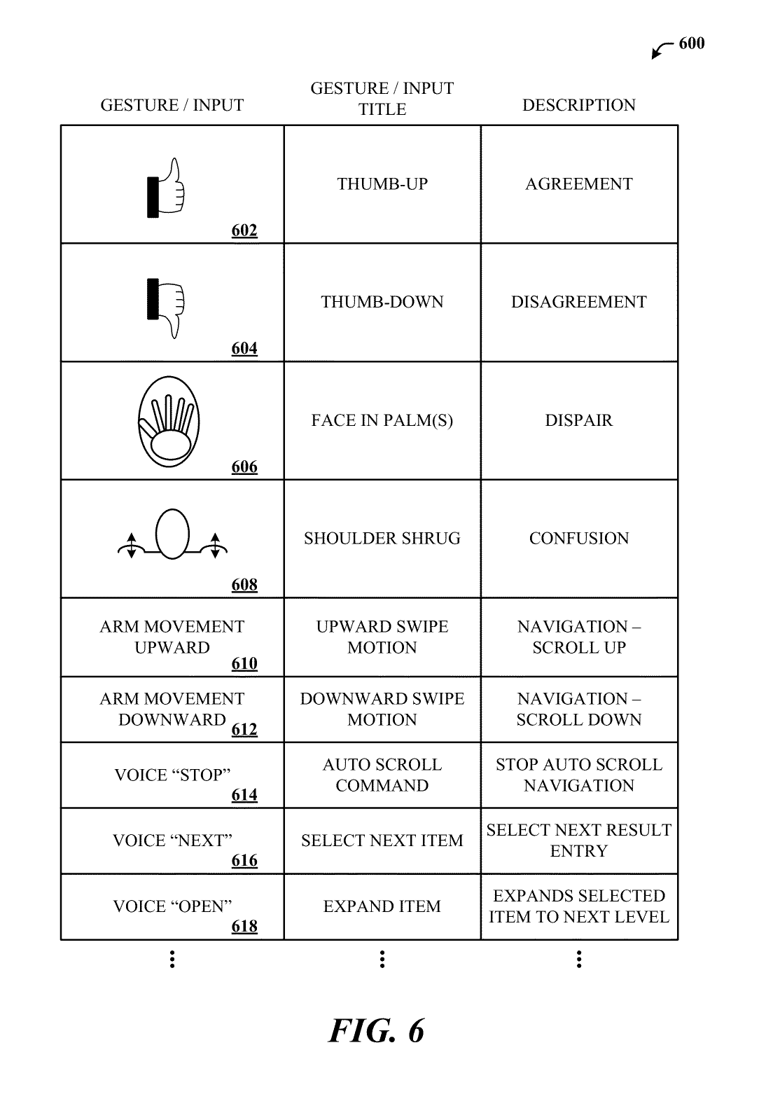

FIG. 6 illustrates a table 600 of exemplary gestures and inputs that can be used for a search input and feedback natural user interface. The thumb-up gesture 602 can be configured and interpreted to represent agreement. The thumb-down gesture 604 can be configured and interpreted to represent disagreement. A palm-in-face gesture 606 can be configured and interpreted to represent despair. A shoulder-shrug gesture 608 can be configured and interpreted to represent confusion. An upward movement of an arm 610 can be configured and interpreted to represent a navigation operation for scrolling up. A downward movement of an arm 612 can be configured and interpreted to represent a navigation operation for scrolling down. A voice command of “stop” 614 can be configured and interpreted to represent a navigation operation to stop an auto-scrolling operation. A voice command of “next” 616 can be configured and interpreted to represent a navigation operation to select a next item. A voice command of “open” 618 can be configured and interpreted to represent a navigation operation to open a window or expand a selected item to a next level.

These are only but a few examples of how the gestures and other types of user input (e.g., speech) can be utilized separately or together to facilitate search and feedback as disclosed herein. The architecture is user configurable so that a user can customize gestures and commands as desired.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

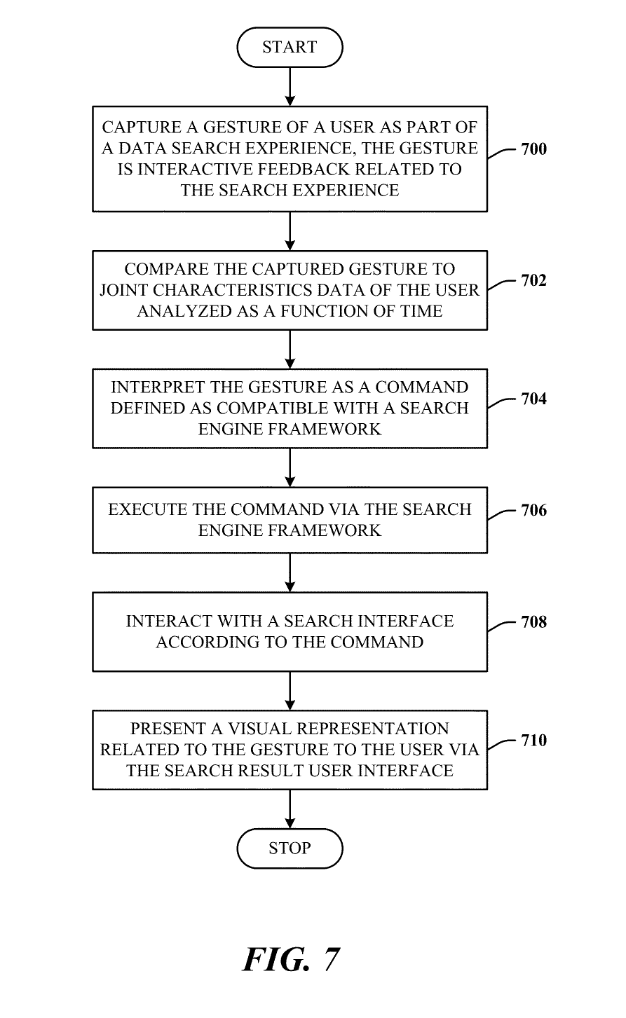

FIG. 7 illustrates a method in accordance with the disclosed architecture. At 700, a gesture of a user is captured as part of a data search experience (where the “experience” includes the actions taken by the user to interact with elements of the user interface to effect control, navigation, data input, and data result inquiry, such as related, but not limited to, for example, entering a query, receiving results on the SERF, modifying the result(s), navigating the user interface, scrolling, paging, re-ranking, etc.), the gesture is interactive feedback related to the search experience. The capturing act is the image or video capture of the gesture for later processing. At 702, the captured gesture is compared to joint characteristics data of the user analyzed as a function of time. The joint characteristics include position of one joint relative to another joint (e.g., wrist joint relative to an elbow joint), the specific joint used (e.g., arm, hand, wrist, shoulder, etc.), transitionary pathway of the joint (e.g., wrist joint tracked in a swipe trajectory), a stationary (static) pose (e.g., thumb-up on a hand), and so on.

At 704, the gesture is interpreted as a command defined as compatible with a search engine framework. The interpretation act is determining the command that is associated with the gesture as determined via capturing the image(s) and comparing the processed image(s) to joint data to find the final gesture. Thereafter, the command is obtained that is associated with the given gesture. At 706, the command is executed via the search engine framework. At 708, the user interacts with a search interface according to the command. At 710, a visual representation related to the gesture is presented to the user via the search interface. The visual representation can be a confirmatory graphic of the captured gesture (a thumb-up gesture by the user is presented as a thumb-up graphic in the interface. Alternatively, the visual representation can be a result of executing a command associated with the detected gesture, such as interface navigation (e.g., scrolling, paging, etc.).

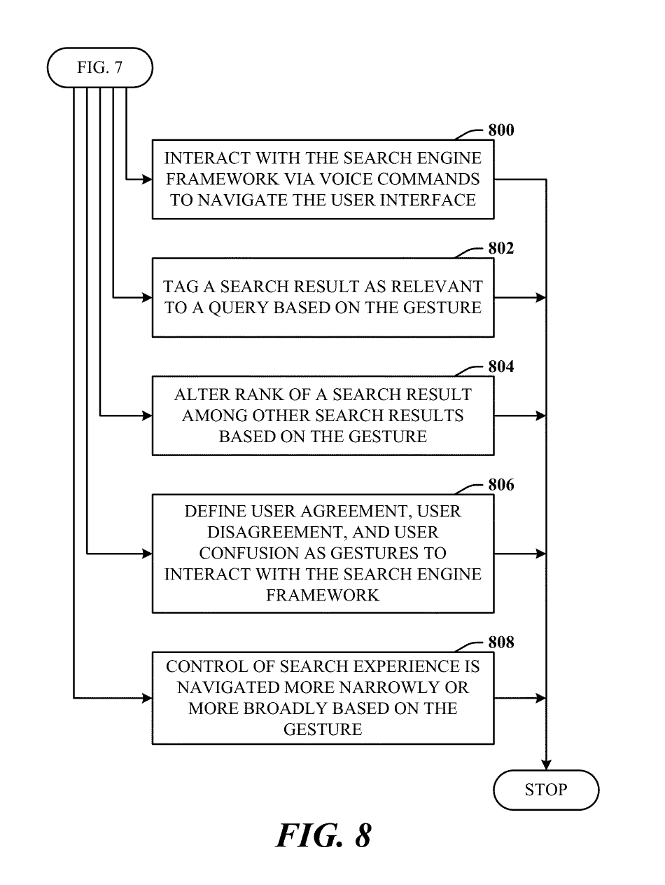

FIG. 8 illustrates further aspects of the method of FIG. 7. Note that the flow indicates that each block can represent a step that can be included, separately or in combination with other blocks, as additional aspects of the method represented by the flow chart of FIG. 7. It is to be understood that the gestures, user inputs, and resulting program and application actions, operations, responses, etc., described herein are only but a few examples of what can be implemented.

Examples of other possible search engine interactions include, but are not limited to, performing a gesture that results in obtaining additional information about a given search result, performing a gesture that issues a new query from a related searches UI pane, and so on. At 800, the user interacts with the search engine framework via voice commands to navigate the user interface. At 802, a search result is tagged as relevant to a query based on the gesture. At 804, rank of a search result among other search results is altered based on the gesture. At 806, user agreement, user disagreement, and user confusion are defined as gestures to interact with the search engine framework. At 808, control of the search experience is navigated more narrowly or more broadly based on the gesture.

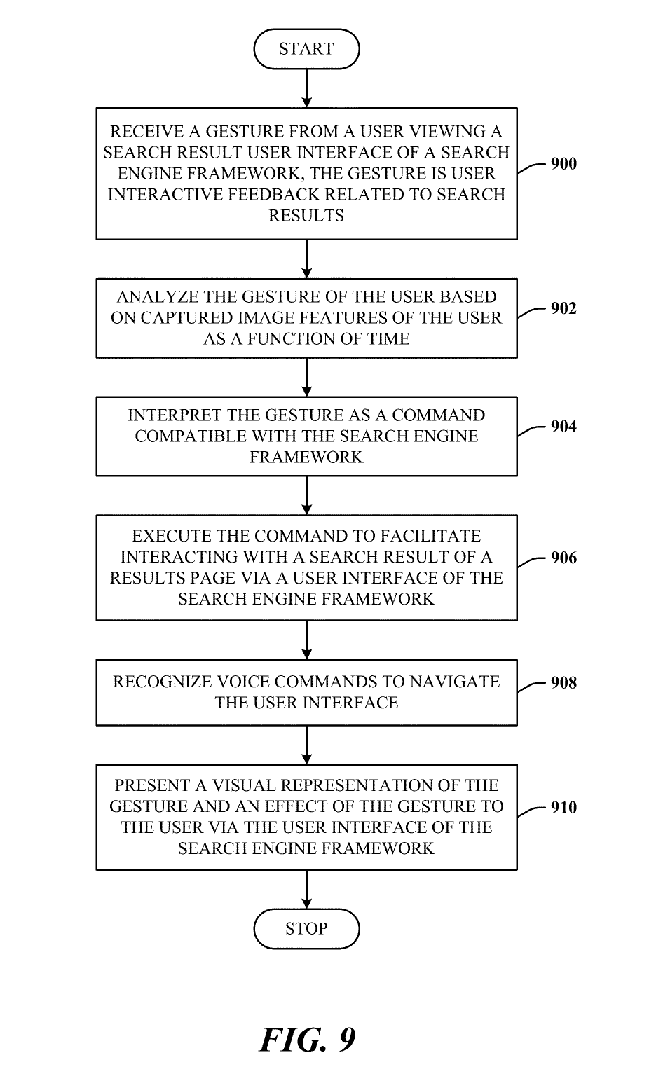

FIG. 9 illustrates an alternative method in accordance with the disclosed architecture. At 900, a gesture is received from a user viewing a search result user interface of a search engine framework, the gesture is user interactive feedback related to search results. At 902, the gesture of the user is analyzed based on captured image features of the user as a function of time. At 904, the gesture is interpreted as a command compatible with the search engine framework. At 906, the command is executed to facilitate interacting with a search result of a results page via a user interface of the search engine framework. At 908, voice commands are recognized to navigate the user interface. At 910, a visual representation of the gesture and an effect of the gesture are presented to the user via the user interface of the search engine framework.

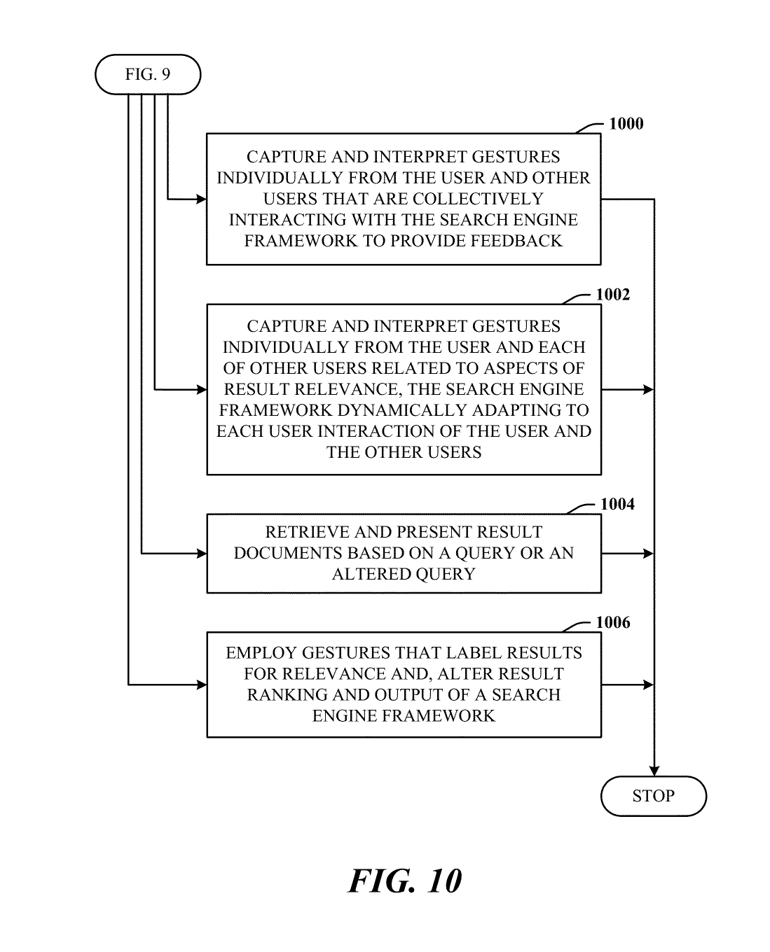

FIG. 10 illustrates further aspects of the method of FIG. 9. Note that the flow indicates that each block can represent a step that can be included, separately or in combination with other blocks, as additional aspects of the method represented by the flow chart of FIG. 9. At 1000, gestures are captured and interpreted individually from the user and other users who are collectively interacting with the search engine framework to provide feedback. At 1002, gestures are captured and interpreted individually from the user and each of the other users related to aspects of result relevance, the search engine framework dynamically adapting to each user interaction of the user and the other users. At 1004, result documents are retrieved and presented based on a query or an altered query. At 1006, gestures are employed that label results for relevance and, alter result ranking and output of a search engine framework.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

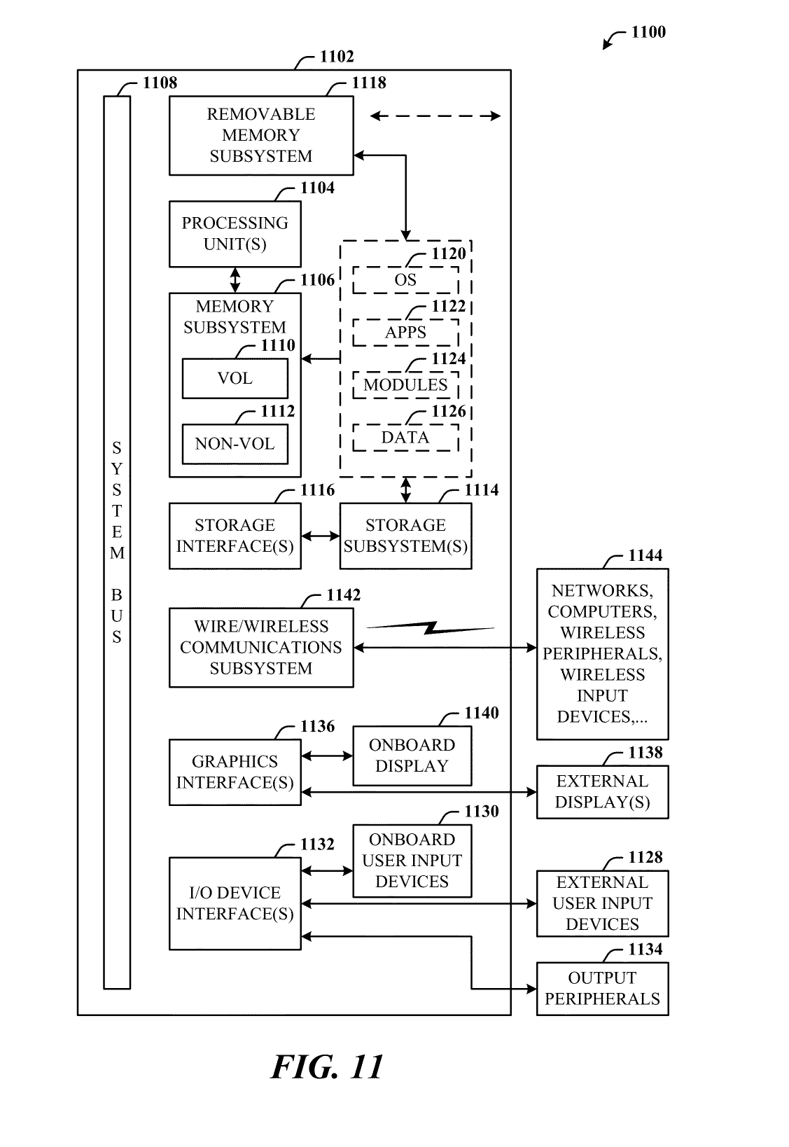

Referring now to FIG. 11, there is illustrated a block diagram of a computing system 1100 that executes gesture capture and processing in a search engine framework in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the user interface 120 of FIG. 2, entities and components of the user interface 120 of FIG. 3, entities and components of the system 400 of FIG. 4, the technique of FIG. 5, the table of FIG. 6, and the methods represented by the flowcharts of FIGS. 7-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media which do not utilize propagated signals and that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse, as well as by voice commands facilitated by speech recognition. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example.

These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a user interaction component in association with a search engine framework that employs a gesture recognition component to capture and interpret a gesture of a user as interaction with the search engine framework, the gesture is user feedback related to interactions with the results and related interfaces by the user to collect data for improving a user search experience; and
a microprocessor that executes computer-executable instructions stored in memory.

2. The system of claim 1, wherein the gesture is recognized based on interpretation of physical location and movement related to joints of a skeletal frame of the user as a function of time.

3. The system of claim 1, wherein the user interaction component is employed to collect data that serves as a label to interpret user reaction to a result via gesture recognition of the gesture related to a search result.

4. The system of claim 1, wherein the gesture of the user is captured and interpreted to navigate in association with a topic or a domain.

5. The system of claim 1, wherein the gesture is captured and interpreted to dynamically modify results of a search engine results page.

6. The system of claim 1, wherein the gesture relates to control of a user interface and user interface elements associated with the search engine framework.

7. The system of claim 1, wherein the captured and interpreted gesture is confirmed as a visual representation in a user interface that is similar to the gesture.

8. The system of claim 1, wherein the gesture is one in a set of gestures, the gesture interpreted from physical joint analysis as a natural behavior motion that represents agreement, disagreement, or confusion.

9. The system of claim 1, wherein the gesture comprises multiple natural behavior motions captured and interpreted as a basis for the feedback.

10. The system of claim 1, wherein the interactions with the results include relevance tagging of results via the gesture to change result ranking.

11. The system of claim 1, wherein the gesture is interpreted to facilitate retrieval of web documents based on a query or an altered query presented to the user.

12. The system of claim 1, wherein the user interaction component further comprises a speech recognition component that recognizes voice signals received from the user that facilitate interaction with a user interface of the search engine framework.

13. The system of claim 12, wherein the voice signals include signals that enable and disable capture and interpretation of the gesture.

14. The system of claim 1, wherein at least one of the gesture or effect of the gesture is communicated electronically to another user.

15. The system of claim 1, wherein the user interaction component operates to capture and interpret gestures individually from the user and other users that are collectively interacting with the search engine framework to provide feedback.

16. The system of claim 15, wherein the user and the other users each interact with aspects of result relevance, and in response to each user interaction the search engine framework dynamically adapts.

17. A method, comprising acts of:
capturing a gesture of a user as part of a data search experience, the gesture is interactive feedback related to the search experience;
comparing the captured gesture to joint characteristics data of the user analyzed as a function of time;
interpreting the gesture as a command defined as compatible with a search engine framework;
executing the command via the search engine framework;
interacting with a search interface according to the command;
presenting a visual representation related to the gesture to the user via the search interface; and
utilizing a microprocessor that executes instructions stored in memory.

18. The method of claim 17, further comprising interacting with the search engine framework via voice commands to navigate the user interface.

19. The method of claim 17, further comprising tagging a search result as relevant to a query based on the gesture.

20. The method of claim 17, further comprising altering rank of a search result among other search results based on the gesture.

21. The method of claim 17, further comprising defining user agreement, user disagreement, and user confusion as gestures to interact with the search engine framework.

22. The method of claim 17, further comprising controlling navigation of the search experience more narrowly or more broadly based on the gesture.

23. A method, comprising acts of:
receiving a gesture from a user viewing a search result user interface of a search engine framework, the gesture is user interactive feedback related to search results;
analyzing the gesture of the user based on captured image features of the user as a function of time;
interpreting the gesture as a command compatible with the search engine framework;
executing the command to facilitate interacting with a search result of a results page via a user interface of the search engine framework;
recognizing voice commands to navigate the user interface;
presenting a visual representation of the gesture and an effect of the gesture to the user via the user interface of the search engine framework; and
utilizing a microprocessor that executes instructions stored in memory.

24. The method of claim 23, further comprising capturing and interpreting gestures individually from the user and other users that are collectively interacting with the search engine framework to provide feedback.

25. The method of claim 23, further comprising capturing and interpreting gestures individually from the user and each of other users related to aspects of result relevance, the search engine framework dynamically adapting to each user interaction of the user and the other users.

26. The method of claim 23, further comprising retrieving and presenting result documents based on a query or an altered query.

27. The method of claim 23, further comprising employing gestures that label results for relevance and, alter result ranking and output of a search engine framework.
